(19) United States
(12) Patent Application Publication
(10) Pub. No.: US 2026/0346260 A1
(43) Pub. Date: Nov. 5, 2026

(54) COMMINUTION APPARATUS WITH MULTIPLE ROTATIONAL CONFIGURATIONS

(71) Applicant: CRE8IC LTD, Stokesley, North Yorkshire (GB)

(72) Inventor: James HOWELL, Stokesley (GB)

(21) Appl. No.: 19/486,087

(22) PCT Filed: May 23, 2024
(86) PCT No.: PCT/EP2024/064302

§ 371 Date: Nov. 20, 2025

(30) Foreign Application Priority Data
May 23, 2023 (EP) 23174966.4

(51) Int. Cl. B02C 2/10; A47J 42/04; A47J 42/06; A47J 42/08

(52) U.S. Cl. CPC B02C 2/10; A47J 42/04; A47J 42/06; A47J 42/08

(57) ABSTRACT

A comminution apparatus is disclosed with at least three sequential feature sets which when configured for relative rotation a sequential pair of feature sets is capable of comminution where relative rotation of at least two feature sets is configured to occur about a single axis, and at least one drive system configured to facilitate said rotation for the at least two feature sets, and wherein the rotation of at least one feature set is configured to occur in a distinct manner to that of the rotation of at least one other feature set.

### CROSS-REFERENCE TO RELATED APPLICATIONS

This application is a U.S. National Phase Application under 35 U.S.C. 371 of International Application No. PCT/EP 2024/064302, filed on May 23, 2024, which claims the benefit of European Patent Application No. 23174966.4, filed on May 23, 2023, the entire disclosure of which is incorporated herein by reference.

### FIELD

The present disclosure relates generally to the field of size reduction equipment, specifically to a novel comminution apparatus that utilises sequential feature sets and distinct relative rotation configurations for efficient and precise material processing. The disclosure is applicable to a wide range of materials, including but not limited to minerals, grains, coffee, pharmaceutical compounds, plastics, and waste materials. It offers a versatile, cost-effective, and easily adjustable solution for size reduction, combining the specificity and throughput of a roller mill with reduced complexity and lower manufacturing costs. The disclosure is particularly suitable for industries requiring precise control over particle size and consistency while maintaining high throughput rates, such as food processing, pharmaceutical manufacturing, and waste recycling. Furthermore, the disclosure relates to a method for comminution of a material in a comminution apparatus is disclosed, the method comprising Introducing pieces of material to a first pair of feature sets; relatively rotating said first pair of feature sets at a first rotational speed about a first single axis so as to reduce the pieces of material in size; introducing the reduced size pieces of material to a second pair of feature sets; relatively rotating said second pair of feature sets about a second single axis at a second rotational speed so as to further reduce the pieces of material in size; wherein the second rotational speed is at an increased rate to that of the first rotational speed.

### BACKGROUND

This section provides background information related to the present disclosure which is not necessarily prior art.

Various types of comminution apparatuses, such as mills and grinders, are known in the art for reducing the size of materials. These include ball mills, roller mills, conical burr mills, flat burr mills, and hammer mills, among others. While these existing devices have been successful in certain applications, they may have limitations in terms of complexity, cost, ease of adjustment, and versatility in handling different materials. There is a need for an improved comminution apparatus that addresses these limitations by providing a more efficient and versatile grinding mechanism with multiple configurable rotational feature sets.

### SUMMARY

This section provides a general summary of the disclosure, and is not a comprehensive disclosure of its full scope or all of its features.

The present disclosure provides a comminution apparatus that combines the specificity and throughput of a roller mill with significantly reduced complexity, making it more cost-effective and easier to manufacture. The apparatus comprises at least three sequential feature sets configured for relative rotation, wherein a sequential pair of feature sets is capable of comminution. The apparatus includes at least one drive system configured to facilitate the rotation of at least two feature sets about a single axis, and the rotation of at least one feature set is configured to occur in a distinct manner compared to the rotation of at least one other feature set.

Unlike conventional roller mills or conical and flat burr grinders, which require setting a precise gap between the burrs, the particle size in the present disclosure can be adjusted simply by controlling the relative speeds between the feature sets. One pair of feature sets breaks the material down to a given size and then feeds it at a specified rate to the next pair of feature sets. This method is analogous to the feeds and speeds of a CNC milling machine, which can produce different chip sizes depending on their settings.

The disclosure provides several advantages, including improved versatility, efficiency, and a wider range of size reduction capabilities for processing various materials. The unique configuration of the feature sets and the adjustable relative speeds make it easier to adapt the comminution apparatus to specific material requirements. This innovative design enables users to achieve precise particle size control without the need for complicated adjustments or expensive manufacturing processes, making it a more cost-effective and user-friendly solution compared to traditional milling technologies.

In summary, the present disclosure offers an improved comminution apparatus that addresses the limitations of conventional mills and grinders by providing a more efficient, versatile, and easily adjustable grinding mechanism with multiple configurable rotational feature sets. The disclosure enables precise control over particle size reduction while maintaining a simpler design, reduced complexity, and lower manufacturing costs, making it an ideal solution for a wide range of applications and materials.

### DETAILED DESCRIPTION OF THE DISCLOSURE

The present disclosure relates to a comminution apparatus with a unique configuration of multiple sequential feature sets designed for relative rotation, providing efficient and precise size reduction of various materials. The following detailed description elaborates on the construction, operation, and potential applications of the disclosure, illustrating its advantages and versatility across different industries.

### Construction and Operation of the Comminution Apparatus

The comminution apparatus comprises at least three sequential feature sets configured for relative rotation. These feature sets are designed to work in pairs, with each pair of feature sets performing the comminution process. The feature sets may include various elements that facilitate shearing, cutting, crushing, grinding, or holding the material in place while the corresponding feature set of the pair acts upon the material.

The construction of the feature sets allows for efficient size reduction through a combination of different comminution mechanisms, depending on the material and desired particle size. By adjusting the relative rotation speed and configuration of the feature sets, the apparatus can achieve a wide range of size reduction capabilities tailored to the specific requirements of the material being processed.

The comminution apparatus includes at least one drive system configured to facilitate the rotation of at least two feature sets about a single axis. The rotation of at least one feature set is configured to occur in a distinct manner compared to the rotation of at least one other feature set. This unique configuration enables precise control over the size reduction process and allows for easy adjustment of the particle size by altering the relative speeds between the feature sets.

### Potential Applications

The innovative design and adjustable nature of the comminution apparatus make it suitable for a wide range of applications across various industries. Some potential applications for the disclosure include:

Food processing: The disclosure can be used to grind spices, nuts, seeds, and other food ingredients to create custom blends, flours, and pastes with precise control over particle size and consistency.

Chemical industry: The comminution apparatus could be utilised in the chemical industry to process raw materials, such as pigments, catalysts, and polymers, into powders or granules with specific particle size requirements for use in various manufacturing processes.

Cosmetic industry: The disclosure could be employed to grind and mix cosmetic ingredients, such as powders, pigments, and fillers, to create consistent formulations with precise particle sizes for improved product performance and user experience.

Agricultural sector: The comminution apparatus could be used to process animal feed, creating custom blends of various grains and feedstocks with specific particle sizes tailored to the dietary needs of different livestock species.

Waste management and recycling: The disclosure could be used to break down and process various waste materials, such as plastics, glass, or electronic components, into smaller particles for easier recycling, disposal, or further processing.

Construction materials: The comminution apparatus could be utilised to produce construction materials, such as cement, gypsum, or lime, by grinding raw materials into the desired particle sizes for optimal performance in various applications.

The detailed description provided above demonstrates the construction, operation, and potential applications of the comminution apparatus, highlighting its versatility and the unique advantages it offers compared to conventional milling technologies. By incorporating the adjustable feature sets and the distinct relative rotation configurations, the disclosure provides a more efficient, cost-effective, and easily adjustable solution for size reduction across a wide range of materials and industries.

### ADVANTAGES OF THE DISCLOSURE

The innovative design of the comminution apparatus offers several advantages over conventional milling technologies, such as roller mills, ball mills, and flat or conical burr grinders:

Simplified construction and reduced complexity: The unique configuration of sequential feature sets and the axially rotational design significantly simplify the construction of the apparatus compared to other milling technologies, leading to lower manufacturing costs.

Easy adjustability: The comminution apparatus does not require setting a precise gap between the feature sets, as is the case with roller mills or conventional burr grinders. Instead, the particle size can be adjusted simply by altering the relative speeds between the feature sets, providing a more straightforward and user-friendly approach to controlling the size reduction process.

Versatility: The adjustable nature of the comminution apparatus makes it suitable for processing a wide range of materials, from minerals and grains to pharmaceutical compounds and food ingredients. Its unique design allows for precise control over particle size and consistency, meeting the specific requirements of various industries and applications.

Enhanced throughput: The sequential arrangement of the feature sets enables the comminution apparatus to achieve high throughput rates while maintaining precise control over the particle size. This feature is particularly beneficial in applications where large volumes of material need to be processed efficiently and consistently.

Improved energy efficiency: The innovative design of the comminution apparatus allows for efficient energy utilisation during the size reduction process, reducing overall energy consumption compared to traditional milling technologies.

In many commercial operations, roller grinders have long been considered the ‘gold standard’ for comminution tasks. Their ability to achieve uniform and precise particle sizes has made them a preferred choice for industries ranging from food processing to pharmaceutical manufacturing. However, despite their widespread usage, roller grinders come with a set of inherent challenges that can affect their efficiency and ease of operation.

The proposed comminution apparatus addresses these challenges, offering several distinct advantages over traditional roller grinders:

Uniform Material Distribution: Roller grinders typically rely on an even distribution of material across the rollers' length and gravity to facilitate material transfer between different grinding stages. This demands precise control and levelling of the equipment. The present comminution apparatus, with its feature sets and rotational design, ensures a uniform and continuous distribution of the material throughout the device, eliminating the need for precise material distribution control.

Controlled Material Transfer: The described comminution apparatus can incorporate a positive displacement mechanism for transferring material between different feature sets. This controlled transfer mechanism avoids the reliance on gravity, offering more flexibility in the system's installation and operation. It allows for more accurate control over the material transfer rate between the feature sets, leading to more consistent comminution outcomes.

Simplicity of Adjustments: Roller grinders require careful adjustments to set the precise gap between the rollers, which can be a time-consuming and delicate operation. In contrast, the present disclosure allows for easy adjustments of the comminution characteristics by simply altering the relative rotational speeds between the feature sets. This simplicity enhances the device's usability and reduces the time required for setup and adjustments.

Flexibility of Configuration: The present comminution apparatus allows for various configurations of feature sets, each capable of performing different types of comminution actions such as shearing, cutting, crushing, and grinding. This adaptability allows the device to be tailored to specific comminution requirements, something not readily achievable with traditional roller grinders.

Lower Manufacturing Costs and Complexity: The present comminution apparatus, by virtue of its design and operational principles, can be manufactured at a lower cost and with less complexity than traditional roller grinders. This makes it a more economically viable solution for a wide range of comminution applications.

Enhanced Versatility: The proposed comminution apparatus's design allows it to handle a wide variety of materials, from grains and coffee to minerals and pharmaceutical compounds. This versatility is not always possible with roller grinders, which may need specific designs or adjustments to handle different types of materials effectively.

These advantages position the present comminution apparatus as a superior alternative to traditional roller grinders, offering greater operational flexibility, control, and cost-effectiveness. It provides an innovative approach to comminution, potentially redefining the ‘gold standard’ in commercial operations.

### Customisation and Adaptability

The comminution apparatus can be further adapted to accommodate specific requirements or preferences across different applications. For example, the drive system of the apparatus can be designed to include a single motor, multiple motors, or even a hand crank, depending on the desired mode of operation and user preference.

Furthermore, the apparatus can be equipped with additional systems, such as thermal management systems for active heating or cooling, or material dosing systems (gravimetric, volumetric, or rotation-based), to enhance its performance and adaptability to specific applications.

In summary, the detailed description provided above highlights the unique features and advantages of the comminution apparatus, showcasing its potential across various industries and applications. Its innovative design, easy adjustability, and versatile nature make it a valuable addition to the field of size reduction technology, offering an improved alternative to conventional milling systems.

### Integration With Other Technologies

The comminution apparatus can be easily integrated with various other technologies to further enhance its functionality and applicability across different industries. Some examples of such integrations include:

Automation and control systems: The apparatus can be equipped with advanced sensors, controllers, and actuators, enabling precise control over the comminution process and real-time monitoring of the output particle size. This integration could help optimise the size reduction process and improve overall process efficiency.

Material handling systems: The comminution apparatus can be combined with various material handling systems, such as conveyors, hoppers, or pneumatic transport systems, to facilitate the seamless transfer of materials between different processing stages or equipment.

Particle analysis and characterization tools: The apparatus can be integrated with particle size analyzers, shape analyzers, or other characterization tools to monitor and evaluate the output material's properties, ensuring consistent product quality and meeting the desired specifications.

Process optimization and modelling software: By integrating the comminution apparatus with process optimization and modelling software, users can simulate and optimise the size reduction process to achieve the best possible performance, energy efficiency, and product quality. To do so, the comminution apparatus can be equipped with at least one of various sensors, like e.g. the particle analysis and characterization tool mentioned above, speed and/or torque sensors for the drive, temperature sensors, mass flow sensors, weight sensors, and the like. The at least one sensor can be connected to a central processing unit which is connected to the drive and/or other elements of the comminution apparatus having impact on the comminution process, like e.g. a material feed controller, a heating/cooling system, or the like. Based on a modelling software running on the central processing unit the central processing unit may control the comminution process by controlling the connected elements.

### Maintenance and Durability

The innovative design of the comminution apparatus not only ensures efficient and precise size reduction but also promotes ease of maintenance and enhanced durability. The simplified construction reduces the number of components and potential points of failure, leading to lower maintenance requirements and longer service life. Furthermore, the modular nature of the feature sets allows for easy replacement or customisation, ensuring the apparatus remains adaptable to changing requirements or industry standards.

Scalability and Adaptability

The comminution apparatus can be designed and manufactured in various sizes and capacities, making it suitable for a wide range of applications, from small-scale laboratories to large-scale industrial processing facilities. Its scalability and adaptability ensure that it can be easily integrated into existing production lines or used as a standalone unit for specific size reduction tasks.

### Environmental Considerations

The comminution apparatus's energy-efficient design contributes to its environmental sustainability. By reducing the overall energy consumption associated with size reduction processes, the apparatus helps minimise the environmental impact of various industries that rely on milling technologies. Additionally, its ability to process waste materials, such as plastics, glass, or electronic components, can aid in waste management and recycling efforts, promoting a more circular economy and reducing the environmental footprint of these industries.

The comminution apparatus described in this detailed description offers a versatile, efficient, and cost-effective solution for size reduction across a wide range of materials and industries. Its unique design, incorporating sequential feature sets and distinct relative rotation configurations, simplifies the construction and operation of the apparatus while providing precise control over particle size and consistency. The apparatus's adaptability, scalability, and integration with other technologies further expand its potential applications and contribute to its value in the field of size reduction technology.

### Embodiments of the Disclosure

In one embodiment, the comminution apparatus includes sequential feature sets, with each pair of feature sets configured for relative rotation about a single axis. The rotation of at least one feature set occurs in a distinct manner compared to the rotation of at least one other feature set.

In another embodiment, the comminution apparatus is designed such that the size reduction achieved by a pair of feature sets is smaller than the size reduction achieved by a preceding pair of feature sets.

In a further embodiment, the relative rotation of a pair of feature sets occurs at an increased rate compared to the relative rotation of a preceding pair of feature sets.

In yet another embodiment, the relative rotation of a pair of feature sets occurs at partially different time intervals compared to the relative rotation of at least one other pair of feature sets.

In various embodiments of the comminution apparatus, the feature sets may consist of diverse geometries and configurations to achieve the desired comminution action on the material being processed. These features may include but are not limited to grooves, teeth, blades, spikes, bumps, apertures, or any other suitable geometries that can effectively shear, cut, crush, grind, or hold the material in place for the other feature set of the pair to act upon.

In addition to these basic geometries, the feature sets may be enhanced with several design improvements to optimise the comminution process and adapt to specific materials or applications:

Adjustable or replaceable features: In some embodiments, the features within a feature set can be adjustable or replaceable, allowing users to modify the geometry, spacing, or orientation of the features to accommodate different material properties or processing requirements.

Wear-resistant materials and coatings: In certain embodiments, the feature sets may be constructed from wear-resistant materials or coated with wear-resistant coatings to prolong their service life and maintain consistent performance over time.

Self-sharpening or self-cleaning features: In some embodiments, the design of the features may enable self-sharpening or self-cleaning mechanisms, helping maintain optimal performance and reducing the need for maintenance and cleaning.

Customizable feature sets: In certain embodiments, the comminution apparatus may allow users to design and manufacture custom feature sets tailored to specific materials or applications, providing greater flexibility and adaptability to different industries and use cases.

Surface treatments or texturing: In some embodiments, the surfaces of the features may be treated or textured to enhance their comminution performance, reduce friction, or facilitate material flow during processing.

These enhancements and variations in the design of the feature sets can help improve the overall performance, efficiency, and adaptability of the comminution apparatus, making it suitable for a wide range of materials and applications across various industries.

In one embodiment of the comminution apparatus, the construction may involve a series of concentric metal burrs with teeth, specifically designed for effective and efficient material processing. These metal burrs can be directly attached to rotors, which include bearings that provide a rigid rotary mounting, ensuring precise and smooth operation during the comminution process.

Additionally, the rotors can be equipped with magnets that enable direct drive by motor stator coils, utilising a brushless DC motor direct drive design.

The detailed description of this embodiment can include the following aspects:

The feature sets may comprise or preferably consist of concentric metal burrs: The metal burrs, featuring teeth designed for shearing, cutting, crushing, or grinding the material, can be arranged concentrically, providing a highly effective comminution surface. This arrangement can also contribute to more uniform particle size distribution and improved output material quality.

Rigid rotary mounting: The rotors, which the metal burrs are directly attached to, can be mounted with bearings that provide a stable and rigid rotary support, ensuring precise and consistent operation during the comminution process. This can lead to better material processing control and reduced wear on the apparatus components.

Brushless DC motor direct drive: By incorporating magnets within the rotors and using motor stator coils for direct drive, the apparatus can benefit from a brushless DC motor design. This design reduces complexity, maintenance requirements, and frictional losses, while improving overall efficiency, reliability, and service life of the apparatus.

In various embodiments of the comminution apparatus, adjustments to the rotational speeds, material feed rates, and other processing parameters can have a significant impact on the physical properties and underlying structure of the output material. By fine-tuning these parameters, users can tailor the comminution process to achieve specific material characteristics and properties that are desired for a particular application or industry.

For example, adjustments to the comminution process may influence:

Structural preservation: In some cases, gentle and precise comminution may be required to preserve the underlying cellular structures, granularity, or texture of the material. This is particularly important for organic materials with complex structures, where preserving the integrity of these structures can impact the material's functionality or performance in specific applications.

Mastication: In certain applications, a more aggressive mastication process may be desired to increase permeability and enhance the solubility of the output material during dissolution processes. This can be particularly important for pharmaceuticals, food processing, and chemical industries, where the rate of dissolution and material interaction can directly impact product performance.

To accommodate these diverse processing requirements and material properties, the comminution apparatus may be enhanced with several design improvements:

Variable speed control: The apparatus may be equipped with a variable speed control mechanism to allow users to adjust the rotational speeds of the feature sets, enabling precise control over the comminution process and its impact on the output material's structure and properties.

Material-specific feature sets: Customizable feature sets can be designed and manufactured to accommodate specific materials or applications, providing greater flexibility and adaptability to different industries and use cases.

Process monitoring and feedback: The apparatus may be integrated with sensors and feedback systems to monitor various processing parameters, such as motor current, material temperature, and material flow rate. This real-time feedback allows users to make informed adjustments to the comminution process to optimise material properties and ensure consistent product quality.

Pre-processing or post-processing treatments: The apparatus may be combined with additional equipment or processes, such as pre-processing for material conditioning or post-processing for material separation or classification, to further enhance the output material's properties and characteristics.

In various embodiments of the comminution apparatus, static electricity can be a significant issue during the comminution process, leading to challenges in handling, processing, and ensuring consistent output material properties. To mitigate these issues, the apparatus may be equipped with systems designed to manage and reduce static electricity generated during the comminution process. These systems can be either passive or active in nature, depending on the specific requirements and desired outcomes.

Passive static mitigation systems: These systems may utilise physical components, such as flaps or wires, to agglomerate particles into slightly larger clumps. By increasing the mass of the particles, the forces generated from the triboelectric attraction can be overcome, helping to reduce the impact of static electricity on the output material. Passive systems offer a simple and cost-effective solution for managing static electricity in the comminution process.

Active static mitigation systems: In more advanced embodiments, the apparatus may be equipped with an active, electrically driven system, such as an ioniser. An ioniser can utilise a series of conductive pins, often made from tungsten carbide, with a high voltage applied to ionise the surrounding air and neutralise any charge on the output material. Active systems offer a more robust and effective solution for managing static electricity, particularly in situations where static issues are more severe or persistent.

It is important to note that while friction during the comminution process can generate triboelectric effects, there may also be scenarios where the net charge remains zero, and the static issue is caused by the migration or separation of positive and negative charges between different particles.

Additional enhancements to the comminution apparatus may include:

Static-resistant materials: Utilising materials with low static generation properties for the construction of the feature sets or other components in contact with the material can help to reduce the overall static generated during the comminution process.

Environmental controls: Implementing humidity and temperature control systems within the processing environment can help to manage the conditions that contribute to static electricity generation, improving overall process stability and output material consistency.

Grounding: Ensuring proper grounding of the apparatus and its components can help to dissipate any built-up static charge, reducing the impact on the output material and improving overall process safety.

By incorporating these enhancements and systems into the design of the comminution apparatus, static electricity-related issues can be effectively managed and mitigated, leading to improved material handling, processing, and output quality across a wide range of applications and industries.

These enhancements and variations in the design of the comminution apparatus can help improve the overall performance, efficiency, and adaptability of the apparatus, making it suitable for a wide range of materials and applications across various industries.

In some embodiments, the comminution apparatus may include a drive system comprising a single motor, multiple motors, or a hand crank to provide relative rotation for pairs of feature sets.

In certain embodiments, the apparatus is equipped with a system for managing the provision of a specific dose of material, such as a gravimetric, volumetric, or rotation-based system, in order to control the flow of material.

In other embodiments, the comminution apparatus may incorporate a system for thermal management, which can include active heating, active cooling, or both, to maintain optimal processing conditions and preserve the quality of the processed materials.

In some embodiments, the comminution apparatus can be integrated with automation and control systems, material handling systems, particle analysis and characterization tools, or process optimization and modelling software to enhance its functionality and applicability across different industries.

In a further embodiment, the comminution apparatus is designed for easy maintenance and enhanced durability, with a simplified construction that reduces the number of components and potential points of failure, and a modular design that allows for easy replacement or customisation of the feature sets.

In certain embodiments, the comminution apparatus is scalable and adaptable, making it suitable for a wide range of applications, from small-scale laboratories to large-scale industrial processing facilities.

In yet another embodiment, the comminution apparatus contributes to environmental sustainability through its energy-efficient design, helping minimise the environmental impact of various industries that rely on milling technologies, and its ability to process waste materials for waste management and recycling efforts.

In some embodiments, the comminution apparatus incorporates sensors and feedback systems to monitor and control the particle size distribution, material flow, temperature, and other processing parameters, ensuring consistent product quality and enhancing process efficiency.

In certain embodiments, the comminution apparatus is designed to accommodate interchangeable feature sets, allowing users to switch between different types of comminution mechanisms, such as shearing, cutting, crushing, or grinding, depending on the specific material and processing requirements.

In another embodiment, the comminution apparatus can be configured to operate in continuous or batch processing modes, providing flexibility in material processing and accommodating various production scenarios.

In a further embodiment, the comminution apparatus may include an integrated cleaning and sanitation system, facilitating easy and efficient cleaning between processing batches, particularly for applications in the food, pharmaceutical, and chemical industries where hygiene and contamination control are critical.

In some embodiments, the comminution apparatus may be designed to operate under various environmental conditions, such as high or low temperatures, high humidity, or corrosive environments, ensuring its adaptability to different industries and application scenarios.

In yet another embodiment, the comminution apparatus may include safety features, such as emergency stop buttons, overload protection, interlocking mechanisms, or protective guards, to

In some embodiments, the comminution apparatus is equipped with a motor current monitoring system that provides real-time process feedback. This system can measure and analyse the current drawn by the motor(s) during operation, which can be correlated to the material properties, processing parameters, and equipment performance. By monitoring motor current, users can gain valuable insights into the comminution process, optimise process efficiency, detect potential issues or anomalies, and make necessary adjustments to maintain consistent product quality and prolong the service life of the equipment.

According to an embodiment of the disclosure, a comminution apparatus is disclosed with at least three sequential feature sets which when configured for relative rotation a sequential pair of feature sets is capable of comminution where relative rotation of at least two feature sets is configured to occur about a single axis, and at least one drive system configured to facilitate said rotation for the at least two feature sets, and wherein the rotation of at least one feature set is configured to occur in a distinct manner to that of the rotation of at least one other feature set.

According to another embodiment of the disclosure, the comminution of a pair of feature sets is configured for a size reduction to a smaller size than that of the configured size reduction of the comminution of a preceding pair of feature sets.

According to another embodiment of the disclosure, the relative rotation of a subsequent pair of feature sets is configured to occur in a distinct manner to that of the relative rotation of at least one preceding pair of feature sets, in that the relative rotational speed of a pair of feature sets is configured to occur at an increased rate to that of the relative rotational speed of a preceding pair of feature sets.

According to another embodiment of the disclosure, the relative rotation of a pair of feature sets is configured to occur in a distinct manner to that of the relative rotation of at least one other pair of feature sets, in that the relative rotation of a pair of feature sets is configured to occur at a partially different time interval to that of the relative rotation of at least one other pair of feature sets.

According to another embodiment of the disclosure, the rotation for at least two feature sets is each configured to occur about different axes of rotation.

According to another embodiment of the disclosure, the rotation for at least three of feature sets is each configured to occur about the same axis of rotation.

According to another embodiment of the disclosure, the relative rotation for at least one pair of feature sets is configured wherein one feature set is retained in a fixed position and the remaining feature set is configured for rotation relative to said fixed position.

According to another embodiment of the disclosure, the relative rotation for at least one pair of feature sets is configured wherein one feature set is configured for rotation in a given direction at a rotational speed and the other feature set is configured for rotation in the same direction at an increased rotational speed.

According to another embodiment of the disclosure, the relative rotation for at least one pair of feature sets is configured wherein one feature set is configured for rotation in a given direction and the other feature set is configured for rotation in the opposite direction.

According to another embodiment of the disclosure, at least one feature set of a pair of feature sets shares a fixed relative arrangement with one feature set of at least one other pair of grinding feature sets.

According to another embodiment of the disclosure, at least one feature set of a pair of feature sets is also the feature set of at least one other pair of feature sets.

According to another embodiment of the disclosure, at least one feature set of a pair of feature sets is formed by a plurality of apertures.

According to another embodiment of the disclosure, at least one feature set of a pair of feature sets is formed by a ring with fluted comminution features.

According to another embodiment of the disclosure, at least one feature set of a pair of feature sets having a varying geometry, so a region of specific geometry may be selectable by translating one feature set position relative to the other feature set.

According to another embodiment of the disclosure, the drive system includes a single motor configured to provide the relative rotation for pairs of feature sets.

According to another embodiment of the disclosure, the drive system includes a hand crank configured to provide the relative rotation for pairs of feature sets.

According to another embodiment of the disclosure, the drive system is configured to provide the initial relative rotation for a given pair of feature sets, and where the subsequent relative rotation for at least one further pair of feature sets is provided by a mechanism coupled between at least one feature set of the given pair of feature sets and at least one feature set of the at least one further pair of feature sets.

According to another embodiment of the disclosure, the drive system includes at least two motors configured to provide the relative rotation for pairs of feature sets.

According to another embodiment of the disclosure, the relative rotation of pairs of feature sets is configured to be activated at least partially non-synchronously.

According to another embodiment of the disclosure, the relative rotation of pairs of feature sets is configured to be activated synchronously.

According to another embodiment of the disclosure, the apparatus includes a system for managing the provision of a specific dose of material.

According to another embodiment of the disclosure, the system for managing the provision of a specific dose of material is a gravimetric system.

According to another embodiment of the disclosure, the system for managing the provision of a specific dose of material is a volumetric system.

According to another embodiment of the disclosure, the system for managing the provision of a specific dose of material is enabled by a specific number of relative rotations.

According to another embodiment of the disclosure, the apparatus is provided with a system for thermal management.

According to another embodiment of the disclosure, at least one feature set is provided with a system for thermal management.

According to another embodiment of the disclosure, the system for thermal management includes active heating.

According to another embodiment of the disclosure, the system for thermal management includes active cooling.

The disclosure further relates to a method for comminution of a material.

According to an embodiment of the disclosure, a method for comminution of a material in a comminution apparatus is disclosed, the method comprising:

Introducing pieces of material to a first pair of feature sets; relatively rotating said first pair of feature sets at a first rotational speed about a first single axis so as to reduce the pieces of material in size;
introducing the reduced size pieces of material to a second pair of feature sets;
relatively rotating said second pair of feature sets about a second single axis at a second rotational speed so as to further reduce the pieces of material in size;
wherein the second rotational speed is at an increased rate to that of the first rotational speed.

According to another embodiment of the disclosure, a method for comminution of material in a comminution apparatus is disclosed, the method comprising:
Introducing pieces of material to a first pair of feature sets; relatively rotating said first pair of feature sets about a first single axis so as to reduce the pieces of coffee in size;
introducing the reduced size pieces of material to a second pair of feature sets;
relatively rotating said second pair of feature sets about a second single axis so as to further reduce the pieces of material in size;
wherein the relative rotation of the first and second pairs of feature sets occurs at least partially non-synchronously.

According to another embodiment of the disclosure, a method for comminution of material in a material comminution apparatus is disclosed, the method comprising:
Introducing pieces of material to a first pair of feature sets; relatively rotating said first pair of feature sets about a first single axis so as to reduce the pieces of material in size;
introducing the reduced size pieces of material to a second pair of feature sets;
relatively rotating said second pair of feature sets about a second single axis so as to further reduce the pieces of material in size;
wherein the maximum permissible rate of comminution of the second pair of feature sets is greater than that of the configured rate of comminution of the first pair of feature sets.

According to yet another embodiment of the disclosure, a method for comminution of a material in a comminution apparatus is disclosed, the method comprising:
Introducing pieces of material to a first pair of feature sets;
relatively rotating said first pair of feature sets at a first rotational speed about a first single axis so as to reduce the pieces of material in size; introducing the reduced size pieces of material to a second pair of feature sets; relatively rotating said second pair of feature sets about a second single axis at a second rotational speed so as to further reduce the pieces of material in size;
wherein the rate of comminution is adjustable to alter the physical characteristics of the comminuted material.

### DRAWINGS

The drawings described herein are for illustrative purposes only of selected embodiment(s) and not all possible implementations, and are not intended to limit the scope of the present disclosure.

Embodiments and details of the disclosure are further descriptive by the following figures.

FIG. 1 shows a sectional view of an embodiment of a comminution apparatus according to the disclosure;

FIG. 2 shows a further section view of details of an embodiment of a comminution apparatus apparatus according to the disclosure;

FIG. 3 shows a further section view of further details of an embodiment of a comminution apparatus apparatus according to the disclosure;

FIG. 4 depicts the flow of the material to be comminuted within an embodiment of a comminution apparatus according to the disclosure;

FIG. 5 depicts another sectional view of an embodiment according to the disclosure adjusted to result in relatively coarse grinds;

FIG. 6 depicts the embodiment according to FIG. 5 adjusted to result in relatively fine grinds;

FIG. 7 shows another embodiment according to the disclosure; and FIG. 8 shows an embodiment according to the disclosure adapted to work with an external drive;

FIG. 9 shows a sectional view of another embodiment according to the disclosure comprising a split burr;

FIG. 10 shows a sectional view of another embodiment according to the disclosure comprising a conical burr in combination with a flat burr;

FIG. 11 shows another embodiment according to the disclosure comprising an adjustable speed auger in combination with a flat burr;

FIG. 12 shows a sectional view of the embodiment as depicted in FIG. 11 comprising an adjustable speed auger in combination with a flat burr;

FIG. 13 shows another embodiment according to the disclosure comprising an adjustable speed auger in combination with a flat burr where the auger is offset from the central axis;

FIG. 14 shows another embodiment according to the disclosure as depicted in 5 and 6

FIG. 15 shows a sectional view of another embodiment according to the disclosure comprising a split burr.

Corresponding reference numerals indicate corresponding parts throughout the view of the drawings.

### DETAILED DESCRIPTION

Example embodiment(s) will now be described more fully with reference to the accompanying drawings.

FIG. 1 shows a sectional view of an embodiment of a comminution apparatus according to the disclosure. The embodiment shown comprises a housing 3, a stator subassy 4 of an internal electrical drive, a small stator subassy 5, a centre shaft 6, a first stage bearing 7, a first stage static burr 8 forming a feature set within the inventive comminution apparatus, a upper rotor 9, a cup 10 forming another feature set within the apparatus, a second stage bearing 11, a conical formed first stage rotating burr 12 forming another feature set within the apparatus, a lower rotor 13, fixation means 14, 15 and 16, a hopper 19, a ring burr 20 forming another feature set of the apparatus, a lower plate 21, a funnel 22, a first static plate 23, a disk 24 (preferably made of a inert plastic material, like e.g. PTFE), and a second static plate 25. Within the embodiment depicted in FIG. 1, the cup 10 and the first stage rotating burr 12 forming a first pair of feature sets in the meaning of the disclosure while the ring burr 20 and the first static burr 8 forming a second and third feature set, respectively. The numbering of the feature sets as first, second or third does not necessarily refer to a subsequent order of contact of the material with the feature sets. The embodiment as shown is driven by an internal drive comprising said stator subassys 4 and 5, as well as the upper rotor 9 and the lower rotor 13.

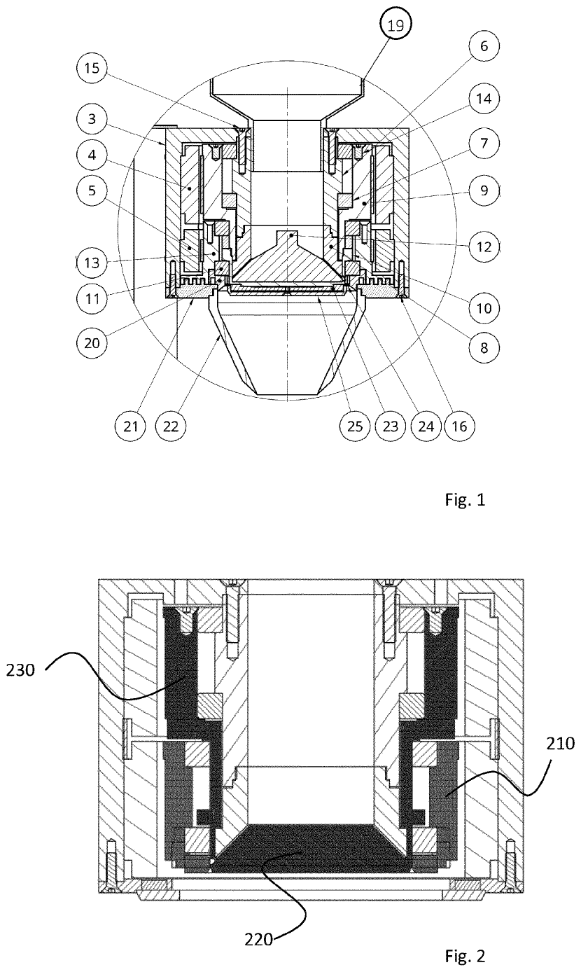

FIG. 2 shows a further sectional view of details of an embodiment of a comminution apparatus according to the disclosure. In the embodiment shown when the apparatus is in working stage element 210 is spinning clockwise, while elements 220 and 230 are spinning counter-clockwise in opposite rotational direction to element 210.

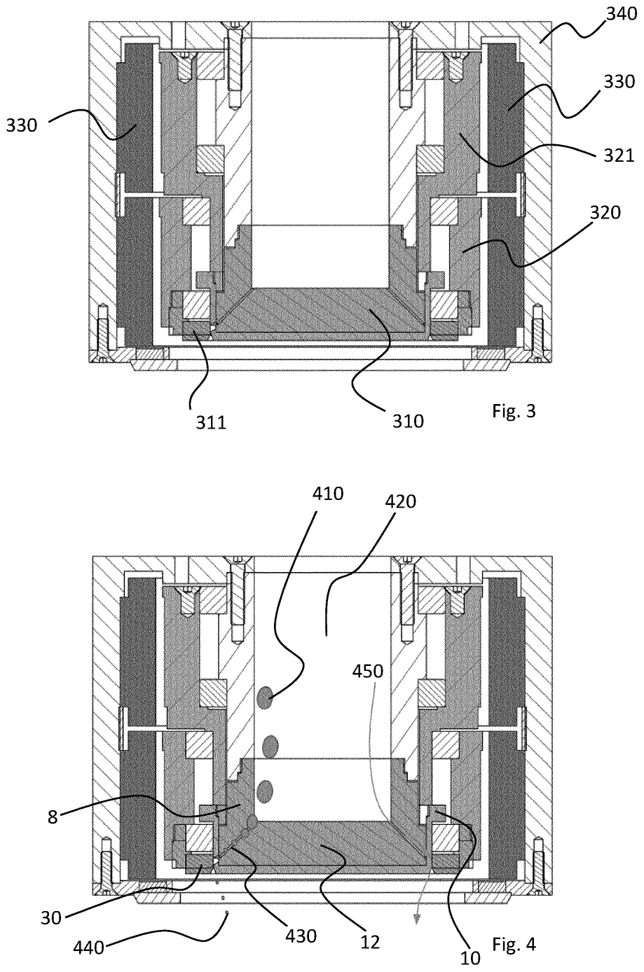

FIG. 3 shows a further section view of further details of an embodiment of a comminution apparatus according to the disclosure having an internal drive. What is shown are burrs 310 and 311, burr carrier 320 and 321, stators 330 of the drive, and a housing 340.

FIG. 4 depicts the flow of the material to be comminuted within an embodiment of a comminution apparatus according to the disclosure. Raw material 410 is loaded into the cavity 420 in which it is pressed by gravity and centrifugal forces of the rotating elements of the apparatus into a gap 430 between the first stage rotating burr 12 and the first stage static burr 8. When leaving the gap 430 the initially grinded material 410 enters into the feature set comprising the first stage rotating burr 12 and the cup 10. Subsequently, the material enters into a feature set comprising the ring burr 20. Finally, the material leaves the apparatus a fine grinded material 440. Arrow 450 additionally symbolises the path of the material 410.

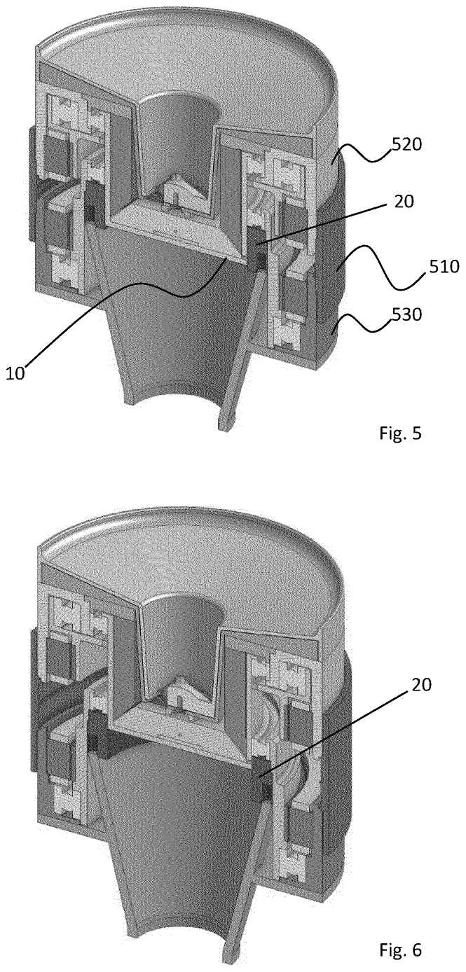

FIG. 5 depicts another sectional view of an embodiment according to the disclosure adjusted to result in relatively coarse grinds. The ring burr 20 has a varying geometry on the inner surface forming the feature set. That varying geometry may be given by a varying distance between the burrs on the inner surface of the ring burr 20, so that the distance between a first pair of burrs may be different from the distance between a second pair of burrs on the inner surface of the ring burr 20. So, a region of specific geometry may be selectable by translating the position of the ring burr 20 relative to the cup 10. In the depicted configuration the selected specific geometry or region, respectively, has a wider distance between two burrs on the inner surface of the ring burr 20 which results in relatively coarse grinds. Adjustment of the selected region may be performed by rotation of the adjustment ring 510. Said adjustment ring 510 may comprise a threat by which the distance between the upper part 520 and the lower part 530 of the apparatus can be varied.

FIG. 6 depicts the embodiment according to FIG. 5 adjusted to result in relatively fine grinds. The selected region of the ring burr 20 having a smaller distance between two burrs on the inner surface of the burr ring 20 which results in relatively fine grinds.

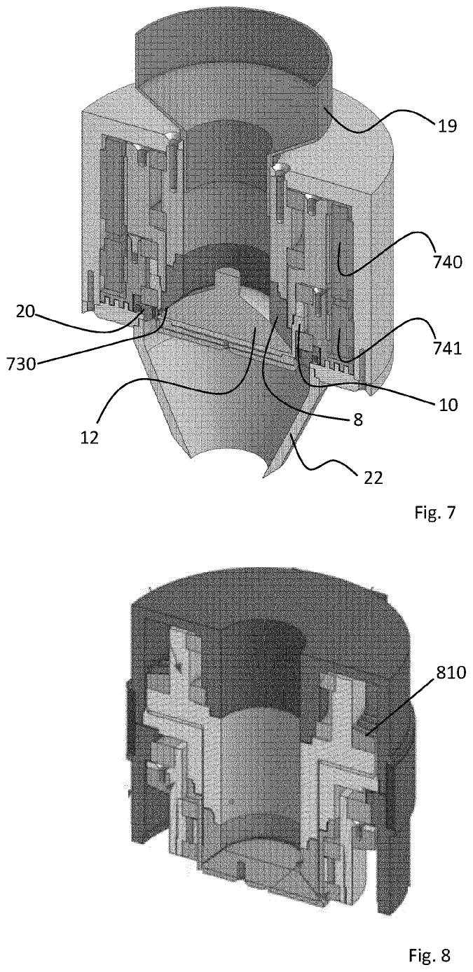

FIG. 7 shows another embodiment according to the disclosure. The material enters the apparatus thru hopper 20 and is conveyed by gravity and centrifugal force into the gap 730 between the first stage rotating burr 12 and the first stage static burr 8. From there it enters into the gap between the cup 10 and the ring burr 20. Finally, the material leaves the apparatus via funnel 22. Rotors 740 and 741 forming a part of the drive of the apparatus.

FIG. 8 shows an embodiment according to the disclosure adapted to work with an external drive. Instead of an internal drive this embodiment comprises a gear 810 which is adapted to interact with a respective gear of an external drive.

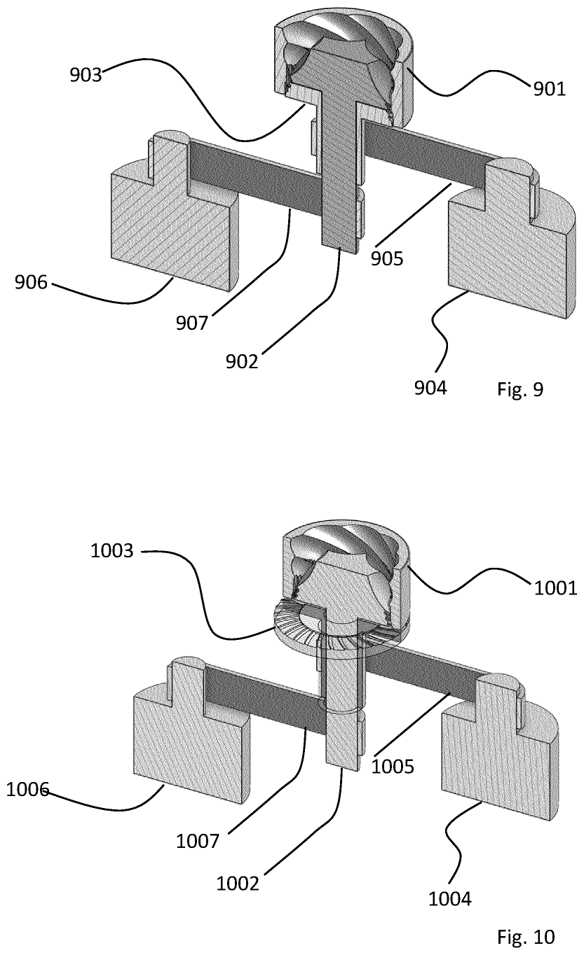

FIG. 9 shows a sectional view of another embodiment according to the disclosure comprising a split burr. The embodiment shown comprises an outer ring 901, a shaft burr 902, and a sleeve burr 903, wherein said outer ring 901, said shaft burr 902 and said sleeve burr 903 form a split burr. The outer ring 901 is static in the meaning that it does not rotate around an axis, while the shaft burr 902 and the sleeve burr 903 rotate around a common center axis. While the rotation can be in common or counter directing relative to each other, it is preferred that the shaft burr 902 and the sleeve burr 903 rotate in a common direction. The shaft burr 902 is driven by a motor 906 via a belt 907, while the sleeve burr 903 is driven by a motor 904 via a belt 905. Alternatively, the shaft burr 902 and the sleeve burr 903 can be driven by a common motor via at least one gear box. The grind can be adjusted by moving the outer ring 901 up and down, relative to the sleeve burr 903, as well by the speed of rotation, especially the differential speed of rotation between the shaft burr 902 and the sleeve burr 903.

FIG. 10 shows a sectional view of another embodiment according to the disclosure comprising a conical burr in combination with a flat burr 1003. The embodiment shown comprises an outer ring 1001, a shaft burr 1002, and a flat burr 1003. The outer ring 1001 is static in the meaning that it does not rotate around an axis, while the shaft burr 1002 and the flat burr 1003 rotate around a common center axis. While the rotation can be in common or counter directing relative to each other, it is preferred that the shaft burr 1002 and the flat burr 1003 rotate in a common direction. The shaft burr 1002 is driven by a motor 1006 via a belt 1007, while the flat burr 1003 is driven by a motor 1004 via a belt 1005. Instead of a belt drive any torque transmission system, like e.g. a gearbox or direct drive, can be implemented. Alternatively, the shaft burr 1002 and the flat burr 1003 can be driven by a common motor via at least one gear box. Due to the specific geometry of the flat burr the grind can be adjusted the speed of rotation, especially the differential speed of rotation between the shaft burr 1002 and the flat burr 1003.

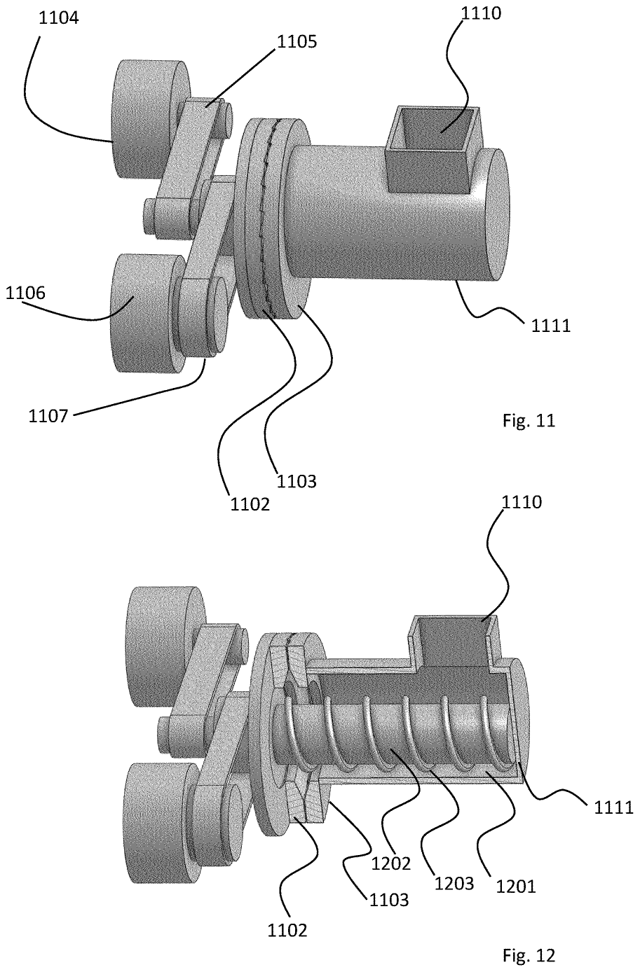

FIG. 11 shows another embodiment according to the disclosure comprising an adjustable speed auger in combination with a flat burr. The embodiment shown comprises a funnel 1110, a housing 1111, a rotating part 1102 of a flat burr, and a static part 1103 of a flat burr. The material to be comminuted is filled in the housing 1111 via funnel 1110. Within the housing an adjustable speed auger is arranged. The auger comminutes the material in a first stage and feeds it towards the flat burr which is formed by the rotating part 1102 and the static part 1103. In a preferred embodiment the static part 1103, the funnel 1110 and the housing 1111 a formed as one piece. Alternatively, at least the static part 1103 and the housing 1111 a separable part. The auger is driven by a motor 1104 via a belt 1105, while the rotating part 1102 of the flat burr is driven by a motor 1106 via a belt 1107. Alternatively, the auger and the rotating part 1102 of flat burr 1003 can be driven by a common motor via at least one gear box.

FIG. 12 shows a sectional view of the embodiment as depicted in FIG. 11 comprising an adjustable speed auger in combination with a flat burr. The embodiment shown comprises a funnel 1110, a housing 1111, a rotating part 1102 of a flat burr, and a static part 1103 of a flat burr. An auger 1202 comminutes the material in a first stage between an inner wall 1201 of the housing 1111 and a coil 1203 of the auger 1202 and feeds it towards the flat burr. The flat burr is formed by the rotating part 1102 and the static part 1103.

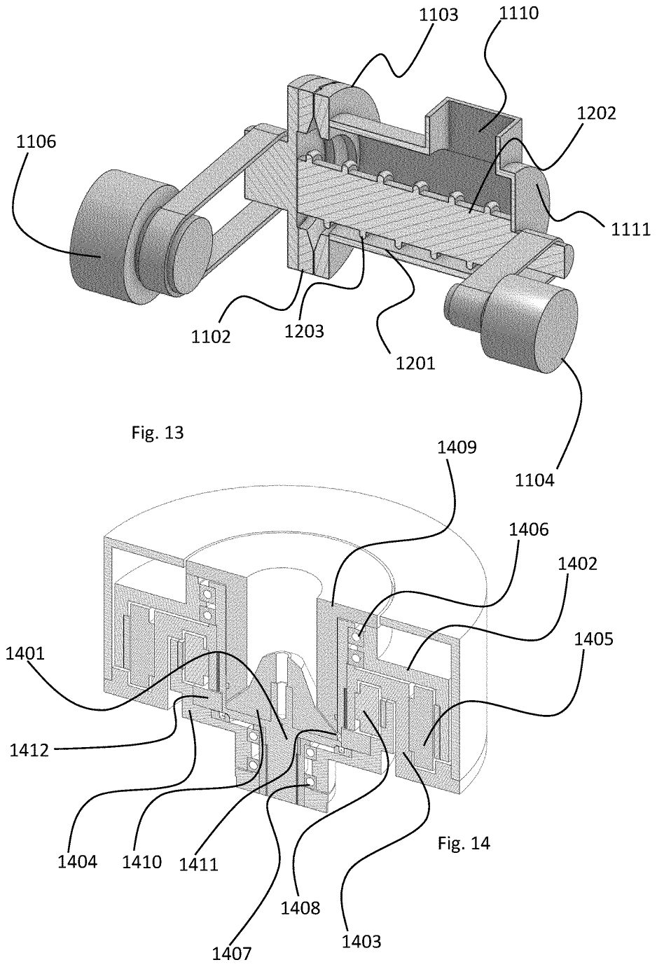

FIG. 13 shows another embodiment according to the disclosure comprising an adjustable speed auger in combination with a flat burr where the auger is offset from the central axis. The embodiment shown comprises a funnel 1110, a housing 1111, a rotating part 1102 of a flat burr, and a static part 1103 of a flat burr. An auger 1202 comminutes the material in a first stage between an inner wall 1201 of the housing 1111 and a coil 1203 of the auger 1202 and feeds it towards the flat burr. The flat burr is formed by the rotating part 1102 and the static part 1103. The auger is driven by a motor 1104, while the rotating part 1102 of the flat burr is driven by a motor 1106.

FIG. 14 shows another embodiment according to the disclosure as depicted in 5 and 6. It depicts another sectional view of an embodiment according to the disclosure. A first rotor 1402 is supported by a bearing 1406 and driven by a direct drive with a stator 1405 and drives a first half on a conical style burr 1409. A cup 1401 is located in the center and forms a stationary part of the apparatus and retains a second half of a conical style burr 1410 and contains a series of ports 1411. A second rotor burr 1404 is supported by a bearing 1407 and driven by a direct drive with a stator 1408 and drives a ring style burr 1412. The first rotor burr 1402 and the second rotor burr 1404 may rotate in common or counter directing relative to each other. The grind can be adjusted the speed of rotation, especially the differential speed of rotation between the first rotor burr 1402, the second rotor burr 1404 and the cup burr 1401.

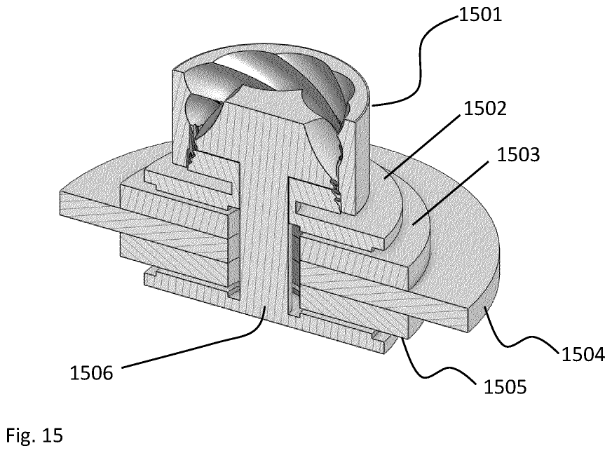

FIG. 15 shows a sectional view of another embodiment according to the disclosure comprising a split burr. The embodiment shown comprises an outer ring 1501, a shaft burr 1506, and a sleeve burr 1502, wherein said outer ring 1501, said shaft burr 1506 and said sleeve burr 1502 form a split burr. The outer ring 1501 is static in the meaning that it does not rotate around an axis, while the shaft burr 1506 and the sleeve burr 1502 rotate around a common center axis. While the rotation can be in common or counter directing relative to each other, it is preferred that the shaft burr 1501 and the sleeve burr 1502 rotate in a common direction. The shaft burr 1506 is driven by a direct drive with a stator 1505 and the sleeve burr 1502 is driven by a direct drive with a stator 1503. The stators 1503 and 1505 a separated by a middle plate 1504.

The grind can be adjusted by moving the outer ring 1501 up and down, relative to the sleeve burr 1502, as well by the speed of rotation, especially the differential speed of rotation between the shaft burr 1506 and the sleeve burr 1502.

The foregoing description of the embodiment(s) has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A comminution apparatus with at least three sequential feature sets which when configured for relative rotation a sequential pair of feature sets is capable of comminution where relative rotation of at least two feature sets is configured to occur about a single axis, and at least one drive system configured to facilitate said rotation for the at least two feature sets, and wherein the rotation of at least one feature set is configured to occur in a distinct manner to that of the rotation of at least one other feature set.

2. The comminution apparatus according to claim 1, wherein the comminution of a pair of feature sets is configured for a size reduction to a smaller size than that of the configured size reduction of the comminution of a preceding pair of feature sets.

3. The comminution apparatus according to claim 1, wherein the relative rotation of a subsequent pair of feature sets is configured to occur in a distinct manner to that of the relative rotation of at least one preceding pair of feature sets, in that the relative rotational speed of a pair of feature sets is configured to occur at an increased rate to that of the relative rotational speed of a preceding pair of feature sets.

4. The comminution apparatus according to claim 1, wherein the relative rotation of a pair of feature sets is configured to occur in a distinct manner to that of the relative rotation of at least one other pair of feature sets, in that the relative rotation of a pair of feature sets is configured to occur at a partially different time interval to that of the relative rotation of at least one other pair of feature sets.

5. The comminution apparatus according to preceding claims claim 1, wherein the rotation for at least two feature sets is each configured to occur about different axes of rotation.

6. The comminution apparatus according to 4 claim 1, wherein the rotation for at least three of feature sets is each configured to occur about the same axis of rotation.

7. The comminution apparatus according to one of the claim 1, wherein the relative rotation for at least one pair of feature sets is configured wherein one feature set is retained in a fixed position and the remaining feature set is configured for rotation relative to said fixed position.

8. The comminution apparatus according to claim 1, wherein the relative rotation for at least one pair of feature sets is configured wherein one feature set is configured for rotation in a given direction at a rotational speed and the other feature set is configured for rotation in the same direction at an increased rotational speed.

9. The comminution apparatus according to claim 1, wherein the relative rotation for at least one pair of feature sets is configured wherein one feature set is configured for rotation in a given direction and the other feature set is configured for rotation in the opposite direction.

10. The comminution apparatus according to claim 1, wherein at least one feature set of a pair of feature sets shares a fixed relative arrangement with one feature set of at least one other pair of grinding feature sets.

11. The comminution apparatus according to claim 1, wherein at least one feature set of a pair of feature sets is also the feature set of at least one other pair of feature sets.

12. The comminution apparatus according to claim 1, wherein at least one feature set of a pair of feature sets is formed by a plurality of apertures.

13. The comminution apparatus according to claim 1, wherein at least one feature set of a pair of feature sets is formed by a ring with fluted comminution features.

14. The comminution apparatus according to claim 1, wherein at least one feature set of a pair of feature sets having a varying geometry, so a region of specific geometry may be selectable by translating one feature set position relative to the other feature set.

15. The comminution apparatus according to claim 1, wherein the drive system includes a single motor configured to provide the relative rotation for pairs of feature sets.

16. The comminution apparatus according to claim 1, wherein the drive system includes a hand crank configured to provide the relative rotation for pairs of feature sets.

17. The comminution apparatus according to claim 1, wherein the drive system is configured to provide the initial relative rotation for a given pair of feature sets, and where the subsequent relative rotation for at least one further pair of feature sets is provided by a mechanism coupled between at least one feature set of the given pair of feature sets and at least one feature set of the at least one further pair of feature sets.

18. The comminution apparatus according to preceding claims claim 1, wherein the drive system includes at least two motors configured to provide the relative rotation for pairs of feature sets.

19. The comminution apparatus according to claim 1, wherein the relative rotation of pairs of feature sets is configured to be activated at least partially non-synchronously.

20. The comminution apparatus according to claim 1, wherein the relative rotation of pairs of feature sets is configured to be activated synchronously.

21. The comminution apparatus according to preceding claims claim 1, wherein the apparatus includes a system for managing the provision of a specific dose of material.

22. The comminution apparatus according to claim 1, wherein the system for managing the provision of a specific dose of material is a gravimetric system.

23. The comminution apparatus according to claim 1, wherein the system for managing the provision of a specific dose of material is a volumetric system.

24. The comminution apparatus according to claim 1, wherein the system for managing the provision of a specific dose of material is enabled by a specific number of relative rotations.

25. The comminution apparatus according to claim 1, wherein the apparatus is provided with a system for thermal management.

26. The comminution apparatus according to claim 1, wherein at least one feature set is provided with a system for thermal management.

27. The comminution apparatus according to claim 25, wherein the system for thermal management includes active heating.

28. The comminution apparatus according to claim 25, wherein the system for thermal management includes active cooling.

29. A method for comminution of a material in a comminution apparatus, the method comprising: Introducing pieces of material to a first pair of feature sets; relatively rotating said first pair of feature sets at a first rotational speed about a first single axis so as to reduce the pieces of material in size; introducing the reduced size pieces of material to a second pair of feature sets; relatively rotating said second pair of feature sets about a second single axis at a second rotational speed so as to further reduce the pieces of material in size; wherein the second rotational speed is at an increased rate to that of the first rotational speed.

30. The method according to claim 29, the method comprising: Introducing pieces of material to a first pair of feature sets; relatively rotating said first pair of feature sets about a first single axis so as to reduce the pieces of coffee in size; introducing the reduced size pieces of material to a second pair of feature sets; relatively rotating said second pair of feature sets about a second single axis so as to further reduce the pieces of material in size; wherein the relative rotation of the first and second pairs of feature sets occurs at least partially non-synchronously.

31. The method according to claim 29, the method comprising: Introducing pieces of material to a first pair of feature sets; relatively rotating said first pair of feature sets about a first single axis so as to reduce the pieces of material in size; introducing the reduced size pieces of material to a second pair of feature sets; relatively rotating said second pair of feature sets about a second single axis so as to further reduce the pieces of material in size; wherein the maximum permissible rate of comminution of the second pair of feature sets is greater than that of the configured rate of comminution of the first pair of feature sets.

32. The method according to claim 29, the method comprising: Introducing pieces of material to a first pair of feature sets; relatively rotating said first pair of feature sets at a first rotational speed about a first single axis so as to reduce the pieces of material in size; introducing the reduced size pieces of material to a second pair of feature sets; relatively rotating said second pair of feature sets about a second single axis at a second rotational speed so as to further reduce the pieces of material in size; wherein the rate of comminution is adjustable to alter the physical characteristics of the comminuted material.
